(19) United States
(12) Patent Application Publication
(10) Pub. No.: US 2015/0317702 A1
(43) Pub. Date: Nov. 5, 2015

(54) SYSTEMS AND METHODS FOR MOVING POSITIONS IN A WAITING LIST

(71) Applicant: 3 Dumbbells LLC, Port Washington, NY (US)

(72) Inventors: Chipeng Liang, Chicago, IL (US); Daniel Reitman, Port Washington, NY (US); Allison Szap, Port Washington, NY (US)

(21) Appl. No.: 14/704,902

(22) Filed: May 5, 2015

Related U.S. Application Data
(60) Provisional application No. 61/988,631, filed on May 5, 2014.

(51) Int. Cl. G06Q 30/02; H04L 12/58; G06Q 20/10; H04W 4/04; G06Q 10/02

(52) U.S. Cl. CPC G06Q 30/0279; H04W 4/04; G06Q 10/02; G06Q 20/10; H04L 51/20

(57) ABSTRACT

A method of changing positions in a waiting list in exchange for a donation to charity includes receiving information regarding a mobile device and a user of the mobile device at a database server to reserve a position in a waiting list at a business establishment, sending a message to the mobile device, determining whether the link displayed on the mobile device is selected, providing a web page to the mobile device enabling the user to make an electronic payment to a charity, determining whether confirmation of a payment for the donation to charity has been received from a payment server, updating the user's current position to a new position in the waiting list when confirmation of a payment has been received from a payment server, and notifying the business establishment and the user of the updated user's current position as the new position.

### BACKGROUND

1. Technical Field

The present disclosure relates to internet connected computers, e.g., a personal computer (PC), and mobile devices, e.g., mobile phones or tablet computers, that execute in a networking environment. In particular, the present disclosure relates to systems and methods for facilitating the purchase, sale, and exchange of a position in an electronically managed waiting list using internet connected computers and mobile devices.

2. Background of Related Art

The sharing of information between personal computers and mobile devices via the Internet is an increasingly popular way of conducting business. In fact, the explosive growth of the Internet and mobile devices is generating changes in classic business and economic models. For example, using network-accessible computer systems (handheld or not), potential customers are able to identify and purchase a wide variety of goods and services from Internet marketplaces. In this regard, the potential customer base and the variability of goods and services provided by online retailers have greatly expanded because geographic limitations are less relevant when conducting business over the Internet.

Frequently, when at maximum capacity, business establishments, e.g., retailers and restaurants, require potential customers to wait in line for a product or service to become available. In this regard, a business establishment may establish a waiting list of potential customers that want to purchase the product or service the business establishment is offering. Currently, these business establishments either use pen and paper, a buzzer system, or computer devices to manage these virtual waiting lists. More generally, due to limited supply, waiting lists are typically formed when a shortage or complete absence exists for the product or services that the business establishment is offering.

Customers that sign-up for or are added to a waiting list by the business establishment are usually served on a first-come first-served basis. Stated differently, potential customers who sign-up for or are added to the waiting list at an earlier time usually have a higher priority over those that are added to the waiting list at a later point in time. In some instances, potential customers at the end of the waiting list may never be able to obtain or purchase the product or service provided by the business establishment because of the limited supply.

In other instances, potential customers may only be able to obtain or purchase the product or service at an undesirable time. In current wait line management systems, a customer is not able to easily purchase a position in the waiting list from or exchange a position in the waiting list with another customer in the waiting list or the business establishment using Internet-connected computers and mobile devices. For example, a potential customer who has a high priority on the waiting list may be willing to sell their position for a specified return of value. Conversely, customers that have a low priority position may be willing to purchase a higher priority position from another potential customer the business establishment itself or a third party system that manages the waiting list on behalf of the business establishment.

In addition, the business establishment or a third party company with rights to sell positions on a waiting list may decide to hold or reserve a specific table, a grouping of seats, a product, or a service for a particular customer on the waiting list. For example, a business establishment may reserve a position, e.g., the first position, on the waiting list for a specific table. When a waiting list starts to form, the held or reserved specific table, seat, product, or service could be offered to the customers. If a customer is willing to purchase access to the first held position or another held position in the waiting list, the customer has an option to pay the business establishment or the third party company a specific amount of money or credits to purchase access to that position in the waiting list.

In existing systems, it may be difficult or impossible for a customer with a high priority position to sell or to exchange their position with another customer. Vice versa, for customers who have low priority positions, the customers have the option to purchase a higher priority position directly from the business establishment or the third party company acting on behalf of the business establishment.

### SUMMARY

The present disclosure features software, applications, and web sites available on mobile devices, which facilitate moving a user's current position to a new position in exchange for making a donation to charity, or the exchange of one user's current position on a waiting list for another user's current position on a waiting list. In addition, the present disclosure features applications or web sites available on mobile devices that facilitate the purchase of a position on a waiting list that is being held for anyone who is interested in purchasing it either directly from the business establishment or the third party company who has the right to sell positions on the wait list. The software application may be used over existing systems used by the business establishments to transmit data to remotely located customers. The systems and methods of the present disclosure benefit computer and/or mobile device users in terms of convenience and efficiency.

The present disclosure features systems and methods for moving positions in a waiting list in exchange for a donation to charity using a mobile device. In embodiments, a method of moving positions on a waiting list in exchange for a donation to charity using a mobile device includes receiving information regarding a mobile device and a user of the mobile device at a database server to reserve a position in a waiting list at a business establishment and sending a message to the mobile device, where the message includes a link and notifies the user of a user's position on a waiting list of the business establishment.

The method further includes determining whether the link displayed on the mobile device is selected, providing a web page to the mobile device enabling the user to make an electronic payment to a charity, if the link is selected, determining whether confirmation of a payment for the donation to charity by the user of the mobile device has been received from a payment server, updating the user's position to a new position in the waiting list if it is determined that confirmation of a payment for the donation to charity by the user of the mobile device has been received from a payment server, and notifying the business establishment and the user of the user's new position on the waiting list.

In another aspect, the present disclosure features a non-transitory computer readable medium storing instructions that, when executed by a computer, implement a method of moving positions in a waiting list in exchange for a donation to charity using a mobile device. The method includes receiving information regarding a mobile device and a user of the mobile device at a database server to reserve a position in a waiting list at a business establishment and sending a message to the mobile device, where the message includes a link and notifies the user of a user's position on a waiting list of the business establishment. The method further includes determining whether the link displayed on the mobile device is selected, providing a web page to the mobile device enabling the user to make an electronic payment to a charity, if the link is selected, determining whether confirmation of a payment for the donation to charity by the user of the mobile device has been received from a payment server, updating the user's position to a new position in the waiting list if it is determined that confirmation of a payment for the donation to charity by the user of the mobile device has been received from a payment server, and notifying the business establishment and the user of the user's new position on the waiting list.

In yet another aspect, the present disclosure features a server for moving positions on a waiting list in exchange for a donation to charity. The server includes a memory configured to store a waiting list of a business establishment, a network device, and a processor. The network device is configured to receive information from a mobile device and transmit a message to the mobile device. The message includes a link and notifies a user of the mobile device of a user's position on the waiting list at the business establishment. The processor is configured to determine whether the link displayed on the mobile device is selected, provide a web page to the mobile device enabling the user to make an electronic payment to the charity, if it is determined that the link is selected, determine whether confirmation of a payment for the donation to the charity by the user has been received from a payment server, update the user's position to a new position in the waiting list stored in the memory if it is determined that the confirmation has been received, and notify the business establishment and the user of the user's new position on the waiting list.

### BRIEF DESCRIPTION OF THE DRAWINGS

Various embodiments of the present disclosure are described with reference to the accompanying drawings wherein:

FIG. 1 shows a diagram illustrating a system architecture providing for changing a user's position in a waiting list in accordance with embodiments of the present disclosure;

FIG. 2 is a flowchart illustrating a process for adding a party to a waiting list in accordance with embodiments of the present disclosure;

FIG. 3 is a flowchart illustrating a process for providing an option to donate to a user when a donation to charity is not enabled by a business establishment in accordance with embodiments of the present disclosure;

FIG. 4 is a flowchart illustrating a process for introducing the charity wait systems and methods in accordance with embodiments of the present disclosure;

FIG. 5 is a flowchart illustrating a process for checking out to make a donation to charity in accordance with embodiments of the present disclosure;

FIG. 6 is a flowchart illustrating a process for updating a waiting list in accordance with embodiments of the present disclosure;

FIG. 7 is a flowchart illustrating a cancellation process in accordance with embodiments of the present disclosure;

FIG. 8 is a flowchart illustrating a sign-up process in accordance with embodiments of the present disclosure;

FIGS. 9-12 illustrate screens displayed on a mobile device for buying a position in a waiting list in accordance with embodiments of the present disclosure;

FIG. 13 is a flowchart illustrating a process for adding a party to a waiting list in accordance with embodiments of the present disclosure; and

FIG. 14 is a flowchart illustrating a method for trading positions in a waiting list in accordance with embodiments of the present disclosure.

### DETAILED DESCRIPTION

As used in the present disclosure, the term waiting list may refer to an electronic waiting list and/or a calendar reservation booking software program or platform that resides on an internet-enabled device such as an iPad/tablet, mobile phones, or computer devices. The electronic waiting list and/or calendar reservation booking software program is used and controlled by a business establishment. The term “third party” may refer to a company that is hosting and supporting the business establishment software applications. The third party not only may host and support the software applications for the business establishment, but also may host and support the software applications residing on the customer's or user's computers and mobile devices. This third party software provider is in essence a middle man for communications between the business establishment's software application and the customer's software application that resides on the customer's mobile device. The term “first position” refers to the front of a waiting list or virtual queue, the position of a next customer or customers in a waiting list to be serviced or seated, or any reserved time or reserved seating at a business establishment.

In one embodiment, the business establishment offers a position, e.g., a first position, in their waiting list to potential waiting customers. In another embodiment, the waiting customers exchange positions with each other independently from the business establishment's control, but still integrating and communicating the results of the position exchange to the business establishment's waiting list program.

A business establishment may use a server that allows adding customers to a waiting list and also allows the business establishment to alert customers of their positions in the waiting list via messages, e.g., text messages. The server receives the customer's phone number to send unique text messages to the customer. In other instances, if the customer has a mobile application for the waiting list on their mobile device, the server can generate instant in-app notifications to communicate with the customer.

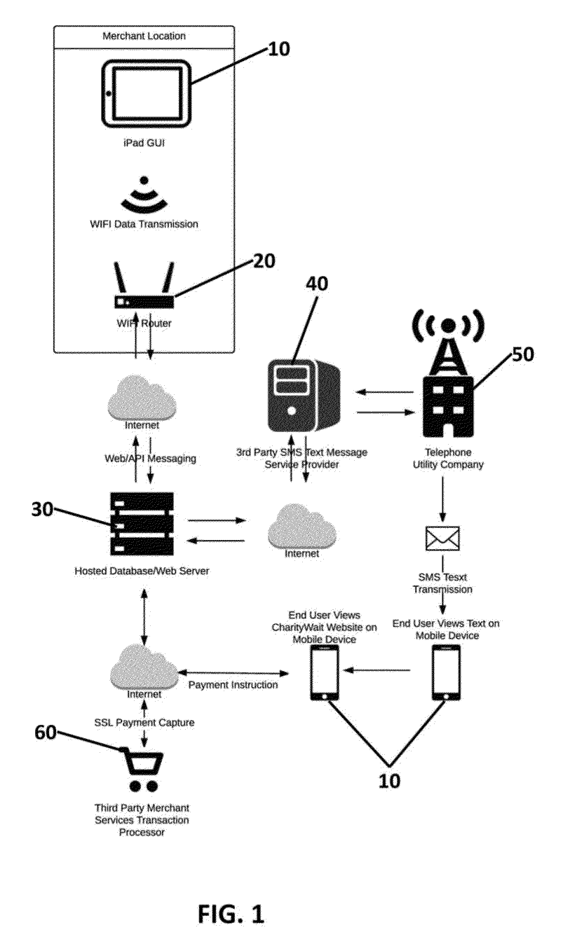

FIG. 1 illustrates a system architecture and associated process of trading or buying a position in a waiting list of a business establishment according to embodiments of the present disclosure. For example, when a mobile user would like to reserve a seat at a business establishment, the mobile user uses a mobile device 10, such as a tablet, smartphone, or other mobile computing device, to connect to the Internet via a WiFi® router 20. In an aspect, the mobile device 10 may connect to the Internet via a cellular data network. Through the Internet, the mobile device 10 connects to a database server 30, which stores and manages a waiting list of the business establishment.

The database server 30 may request information needed to reserve a position in the waiting list and receive the information from the mobile device. As is customary, when there are enough seats available at the time of the reservation, the mobile user and the mobile user's party can immediately be seated in the seats. However, when all seats have been reserved already, the mobile user is added to a waiting list. In such a case, the database server 30 adds the mobile user to the waiting list, which may place the mobile user behind other customers on the waiting list.

In a case where the mobile user would like to change his position on the waiting list to the first position on the waiting list, the database server 30 may contact a third party short messaging service (SMS) provider 40 to transmit a message to the mobile device 10. The third party SMS provider 40 may transmit the message to the mobile device 10 via a telephone utility company 50. In an aspect, the third party SMS provider 40 may directly transmit a message to the mobile device 10 via the Internet. The message may include a link to donate to a charity and indicate that the mobile user may buy the first position of the waiting list by making a donation to charity. Here, the first position may be the next in line for a table or a grouping of seats.

If the mobile user views the message and would like to change his position to the first position on the waiting list, the mobile user is directed to make a donation via the link. The mobile user may then donate an amount of money to the charity via a third party merchant services transaction server 60.

When the payment is successfully made, the third party merchant services transaction server 60 sends payment confirmation messages to the mobile device 10 and the database server 30. Then, the database server 30 changes the mobile user's position on the waiting list to the first position on the waiting list and updates the waiting list. The database server 30 also sends a message to the mobile device 10 indicating the updated position of the mobile user.

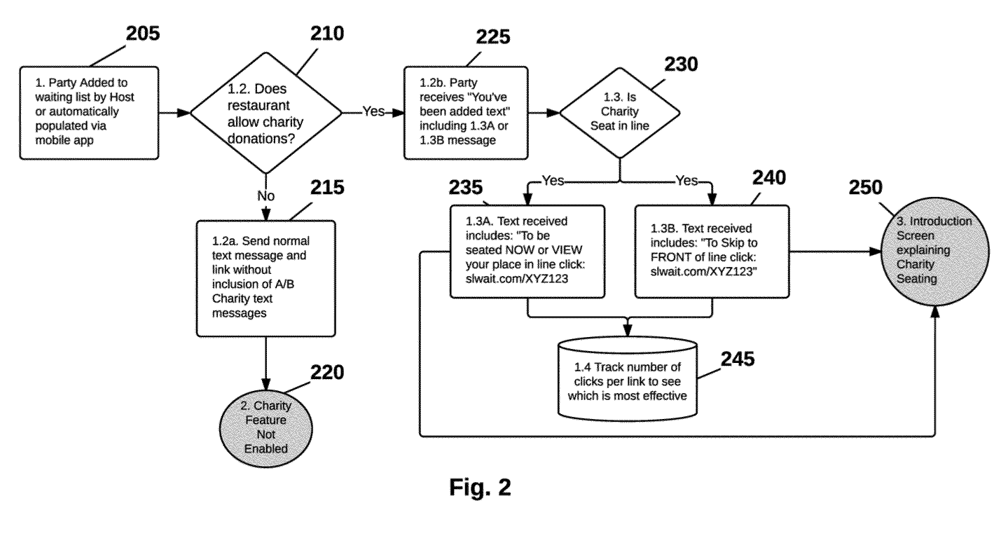

FIG. 2 is a diagram illustrating a method of adding a customer to a waiting list. A business establishment may use a wait list management program that is provided by a third party (Host server) that facilitates the trading position transaction. When a potential customer requests a seat in the business establishment, the potential customer is added to the waiting list in the last position, in step 205, when there are no seats available.

In step 210, the Host server determines whether the business establishment allows a customer to buy the first position by donating to a charity. If it is determined that the business establishment does not allow a customer to buy the first position by donating to a charity, the Host server may send a normal SMS message to the customer without a link to make a donation to charity, in step 215. In this case, the charity donation feature is not enabled and the process ends in step 220.

On the other hand, if it is determined that the business establishment does allow a customer to buy the first position in the waiting line by donating to a charity, those customers who furnish the business establishment with their phone number are sent an SMS text message containing a custom greeting plus a unique code and URL hyper link, in step 225. In an aspect, customers may receive an instant in-app notification if the customers have installed a mobile application, which is related to the business establishment's wait list management application, on their mobile device. The in-app notification originates from the waiting list management program being controlled by the business establishment.

In step 230, it is determined whether a charity table or a group of charity seats is available. If it is determined that a charity table is available, an SMS message may be sent to the customer indicating that the customer can be seated at the charity table, and including a link to enable the customer to donate to a charity so that the customer can be seated at the charity table, thereby bypassing the waiting line.

When it is determined that the charity table is not available, an SMS message is sent to the customer indicating that the customer can change his position in the waiting list to the first position and also include a link to make a donation to a charity to bypass the waiting line, in step 240.

In an aspect, when the customer clicks the link in steps 235 and 240, the Host server may track the number of user's clicks in either situation and check which situation is more effective than the other, in step 245. In another aspect, when the customer clicks on the link in steps 235 and 240, the mobile device may show screens explaining the charity seating in step 250.

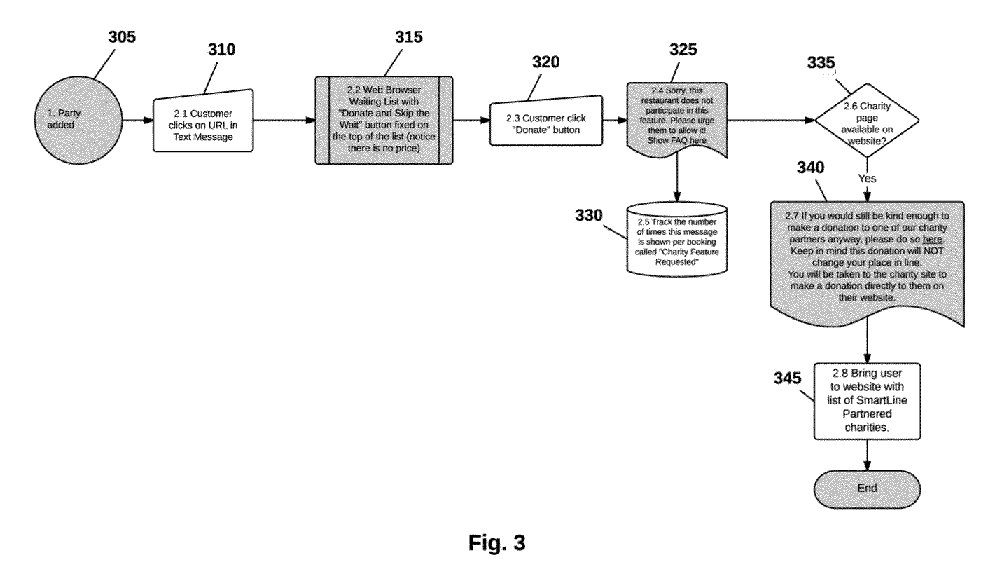

FIG. 3 illustrates a process after a customer is added to the waiting list. When the customer is added to the waiting list in step 305, the customer receives a message including a link. When the customer clicks the link in step 310, a web browser of the mobile device shows in a web page the customer's position in a waiting list and a button for donating to a charity to skip the waiting list in step 315. The customer can click the donation button in step 320.

If the business establishment does not allow a customer to skip the waiting list by making a donation to charity, a message is sent to the customer's mobile device indicating that the business establishment does not allow a customer to skip the waiting list by making a donation to charity in step 325. In an aspect, the web page may allow the customer to request the charity feature. The web page may include a message asking the customer whether the customer would like to suggest to the business establishment that it enable the feature allowing a customer to skip the waiting list by making a donation to charity. In step 330, the database server may track the number of times this message is displayed.

The web page is hosted and provided by a Host server, who is authorized to represent the business establishment for their customers. In an aspect, when a customer views the web page linked in the message, the customer may first see a video or graphical tutorial explaining a service that the business establishment is offering through the Host server. The tutorial may explain to the customer that the business establishment is currently holding the first position in the waiting list for a charity organization. In this way, customers may have an option to pay a specific amount of money as a donation to charity to change from their current positions in the waiting list into the first position in the waiting list.

The customer may be informed that the business establishment is not the recipient of the money paid for the first position. The customer may be also informed that the proceeds of the transaction for the first position are split between a charity, which the business establishment may preselect, and the Host server that processes the transaction. The customer may optionally be able to browse further from the tutorial to gain more detailed information and read a list of frequently asked questions with answers that explain the process of making a donation to charity to change to the first position as well as the terms and conditions.

In step 335, it is determined whether a web page for making a donation to charity is available. If not, a message may be further displayed to lead the customer to make a donation in step 340. The message may indicate that a donation cannot be made to change the customer's current position in the waiting list to another position. If the customer would like to make a donation to charity and selects a donation button displayed in the web page, the web browser brings the customer to another web page listing charities, in step 345, and enables the customer to donate to a charity, which the customer selects or which the Host server has preselected.

In another embodiment, a business establishment may use a wait list management program which is provided by a third party. The wait list management program may be integrated and communicate electronically with the Host server's customer software application. The third party's wait list management program may generate a text or in-app message to the customer. This message may contain a unique code and URL that leads to a web page showing the customer's current position in the waiting list. This unique code may allow the wait list management program to properly handle changes that the customer may make to their booking information and position in the waiting list, and reflect these changes in the waiting list automatically.

If the business establishment does not use a waiting list that is provided by the Host server or does not integrate the waiting list with the Host server customer software application, the business establishment may need to create an account with the Host server. The Host server may then provide the business establishment with a unique code. The business establishment may provide the same unique code and URL in their SMS text link sent to all the customers, originating from the third party's wait list management program. Customers may then be directed to a tutorial.

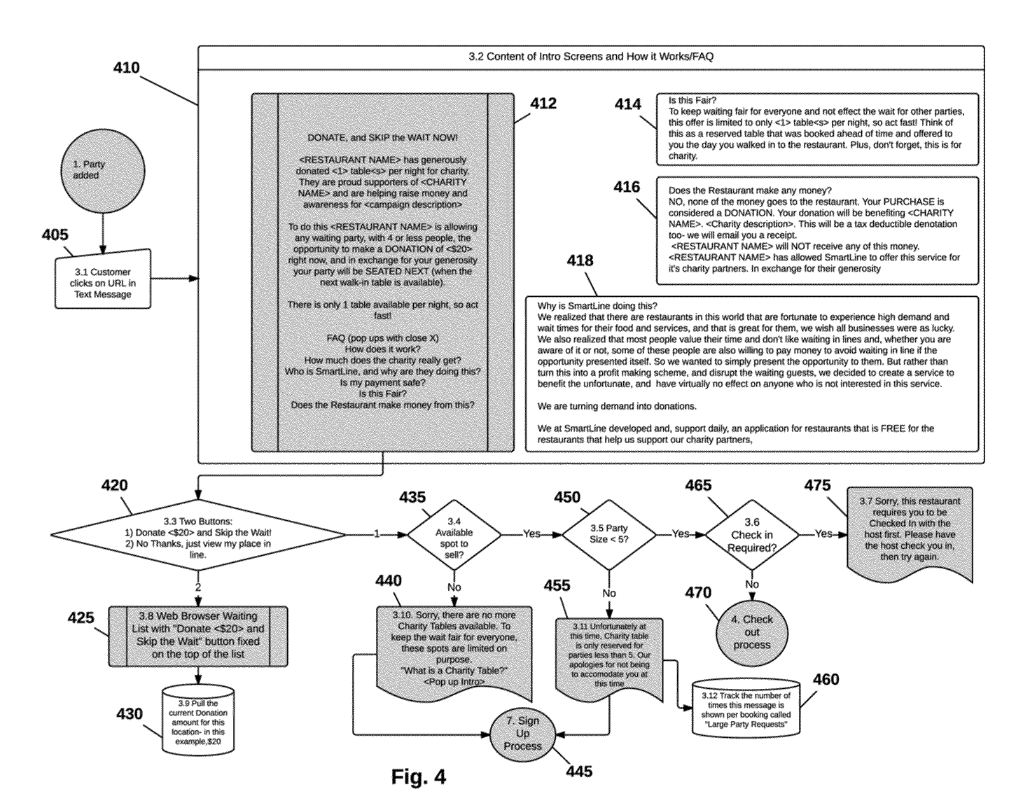

FIG. 4 illustrates a tutorial according to an embodiment of the present disclosure. When a customer is added to the waiting list and clicks a URL in a text message in step 405, the web browser may display introduction information about making a donation to a charity to skip a waiting line or move to another position in a waiting line in step 410. The introduction information may include the name of the business establishment, the number of charity seats or charity tables, an amount of a donation to reserve a charity seat or charity table, and frequently asked questions (FAQ), as shown in box 412. The introduction information may further include why the charity seat or charity table is fair, as shown in box 414.

The introduction information may inform the customers that the proceeds of the donation are not given to the business establishment and that the donation may be tax-deductible, as shown in box 416. The introduction information may further include information about the third party (the Host server).

The web page may further include two buttons: a donate or purchase button to change positions in the waiting line or a “No Thank You” button to stay in the customer's current position in the waiting list in step 420. In an aspect, the web browser may receive the donation amount from the Host server and display the donation amount on the donation button, as illustrated by steps 425 and 430.

By clicking the donation button, the customer agrees to pay the specified amount of money (specified by the business establishment) in exchange for moving the customer from the customer's current position in the waiting list to the first position in the waiting list. Several conditions need to be met in order for the customer to complete the transaction. The first condition that needs to be met before a first position can be purchased is whether the business establishment actually has an available reserved first position for sale in its inventory (step 435).

In an aspect, the business establishment may have the ability to control the number of first positions that are available for sale within a given time period. For example, the business establishment can decide to allow only two first positions to be available for sale every ninety minutes. Another example where the business establishment could control the availability would be to only make a first position available for sale one time in the lifecycle of any customer's wait. What this means is if a customer is in the 15th position in line on a waiting list and decides to purchase the first position that is available for sale, then their current position (i.e., 15th) will become the next “first position” available to purchase. However, this 15th position “first position” will not actually be available to purchase until all fourteen customers in front of the 15th position are no longer waiting or have been seated or removed from the list.

This guarantees that it is not possible for any customer who joins the list to ever experience another customer, who is behind their position purchasing and moving in front of them into the first position more than once during their time spent waiting in line.

If there is no available first position, a message indicating that there are no more charity seats or tables available is displayed on the mobile device in step 440. In an aspect, the message may further include an explanation of the charity seats or tables and ask the customer to sign up with the charity seat management program in step 445.

If the first condition is met, then the second condition that needs to be met before a reserved first position can be sold is that the customer's party size must be less than what the business establishment allows in order to purchase a first position. In an aspect, the business establishment's customers may be grouped into parties. For example, the business establishment could decide to only allow customers grouped in party sizes of 4 or less to purchase a first position in the waiting list. In step 450, it is determined whether the party size is less than a predetermined size set by the business establishment. If the party size is not less than the predetermined size, another message is sent to the customer information the customer that the business establishment only provides charity seats for a group size less than the predetermined size in step 455. In an aspect, the message may further include an invitation to sign up with the charity seat management program in step 445. In another aspect, the customer may make a request for a larger party in step 460. The management program may track the number of requests for the larger party and provide these statistics to the owner of the business establishment.

If the first and second conditions are both met, then the third condition that needs to be met before a reserved “first position” can be sold is whether or not the customer and every member of their party is physically located at the business establishment and has checked in with an employee of the business establishment in step 465. The business establishment may optionally not allow customers to purchase the first position if the entire party is not physically present at the establishment. The method for determining whether the customer is physically present is for the customer to notify an employee in person that they and all members of their party are physically present at the business establishment. The third condition may be an optional requirement by the business establishment.

If it is determined that not every member of the party has checked in at the business establishment, a message is displayed indicating that all members of the party must be physically present to move to the first position in the waiting list in step 475. If it is determined that third condition is met, a check-out process follows in step 470.

If any of these conditions is not met, then the customer will be shown a message after clicking on the donate/purchase button that they cannot purchase the first position for the reason that they do not satisfy one of the required conditions for this business establishment as illustrated in steps 440, 445, and 475. In an aspect, the customer may be asked to provide contact information and permission for the Host server's software program to create an account so they may be contacted with information about this service. Customers may also be asked if they want to still make a donation and have 100% of the proceeds go to the selected charity. The message may indicate that this purchase has no effect on their position in the waiting list, and they are not purchasing a first position. Instead they would be voluntarily making a donation to this charity.

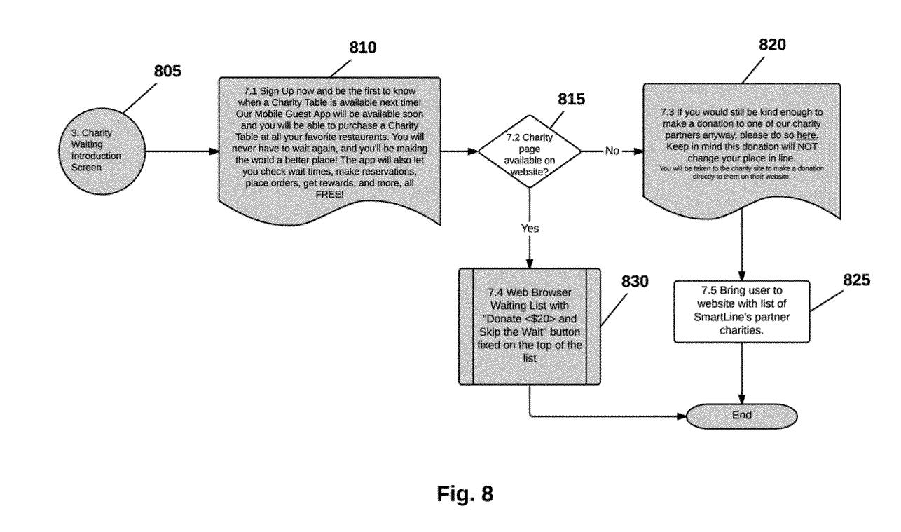

After all the conditions above are satisfied, the customer is brought to a secure check-out page in which the software is able to capture and process their payment information and transfer the purchase amount from a credit card to the Host server's bank account, which is illustrated in FIG. 8. In step 805, a screen introducing a group of charity seats or a charity table is displayed on the mobile device of a customer. The screen further shows other information for sign up in step 810. The customer who signs up may receive a notification when a group of charity seats or a charity table is available at a business establishment and may receive related information, such as waiting time, making reservations, placing orders, getting rewards, and so on.

In step 815, it is determined whether a web page for donating to a charity to move to the first position in the waiting list is available. When there is no web page for donating to a charity to move to the first position in the waiting list, a message is displayed to indicate that the customer can still donate money to a charity but that the customer cannot be moved from the customer's current position to the first position in the waiting list in step 820. In a case where the customer would like to donate money to the charity, the web browser may direct the customer to a web page to donate money to the charity in step 825.

When it is determined that the web page for donating to charity to move to the first position in a waiting list is available, the web browser displays a button with information for donating money to a charity and skipping to the first position in a waiting list in step 830.

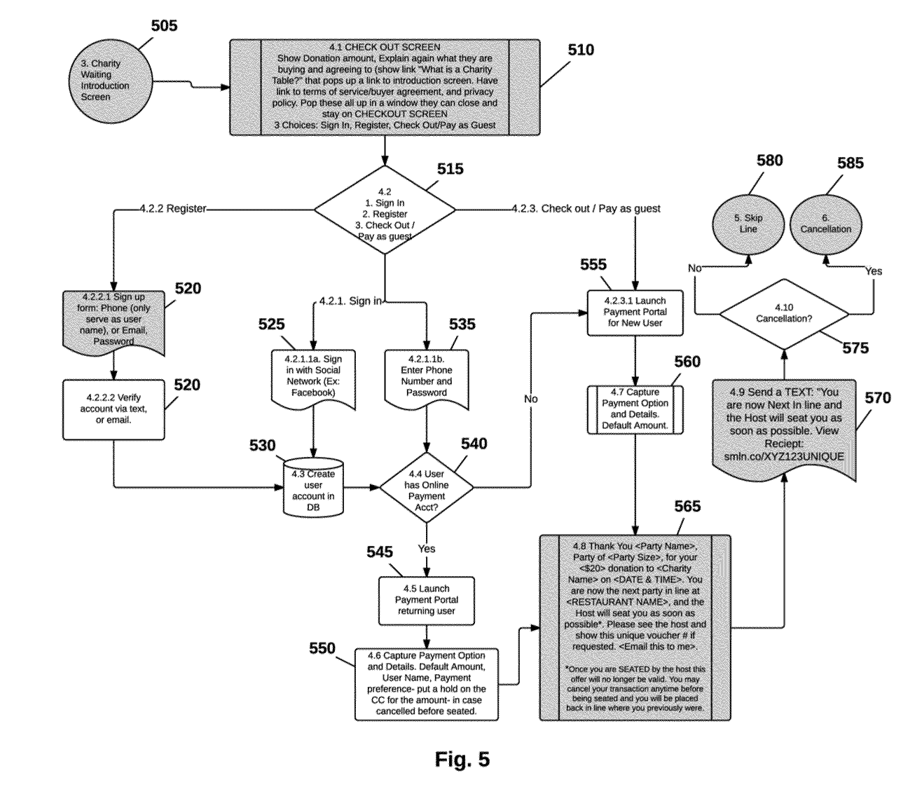

Then the customer will be brought to a secure check-out page as shown in FIG. 5, in which the Host server can capture and process their payment information and transfer the purchase amount from a credit card to the Host server's bank account. After the payment is captured, the proceeds in the Host server's bank account will be split between the Host server and the charity that the business establishment pre-selected. The customer will then receive a text message or an in-app notification and an email with the receipt of the transaction. This receipt may act as proof of their purchase and state how much they paid, what service they are getting in return for this amount, and include a unique identifier specific to their transaction. From this point the customer experience may have two paths.

In a first path, if the business establishment is using an electronic waiting list that is integrated with the Host server's customer software application, then the customer's position in the waiting list that is controlled by the business establishment may automatically be updated. The employee of the business establishment controlling the waiting list then sees that customer's name and party information within the first position in the waiting list after the transaction is processed. The employee also sees that the customer's previous position in the waiting list has changed. The new party name may be “Charity Table”. It is also clear to the employee that this position sold is now being held in line as the next Charity Table. This Charity Table will continue to move as the parties in front of the customer's previous position are exiting the line. Eventually, the Charity Table becomes the “first position” and at that point becomes available for sale to other customers in the waiting list.

In a second path, if the business establishment is not using an electronic waiting list that is integrated with the Host server's customer software application, then the customer needs to communicate and show the receipt they received directly to an employee of the business establishment to indicate a change in position. The business establishment may have access to its unique web portal provided by the Host server where they can configure any conditions of sale, the sale price, pre-select a charity, and any other terms of sale for the first position in the waiting list. This web portal may also give the business establishment the ability to view and search for any purchases made for a first position. The date, time, and unique ID shown on the customer's receipt may allow the business establishment to keep track of the purchase status to ensure that the customer is not able to redeem the same service multiple times.

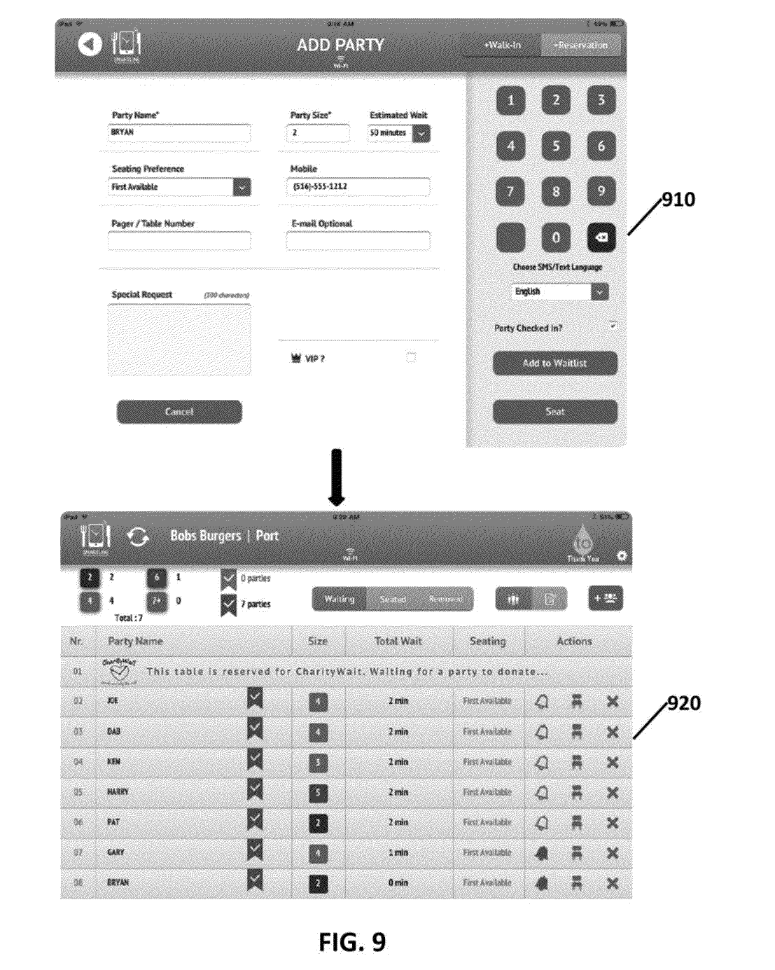

FIGS. 9-12 illustrate the operation of the waiting list management software according to embodiments of the present disclosure. In FIG. 9, a party's name, the size of the party, mobile number, and an option to walk in or make a reservation are shown in screen 910. After the party is added to the waiting list, screen 920 shows the waiting list and the current position of the party. For example, BRYAN is added to the waiting list and is shown in the eighth position of the waiting list. As shown in screen 920, the first position is originally empty because it is reserved for a customer who wants to move to the first position by donating to a charity.

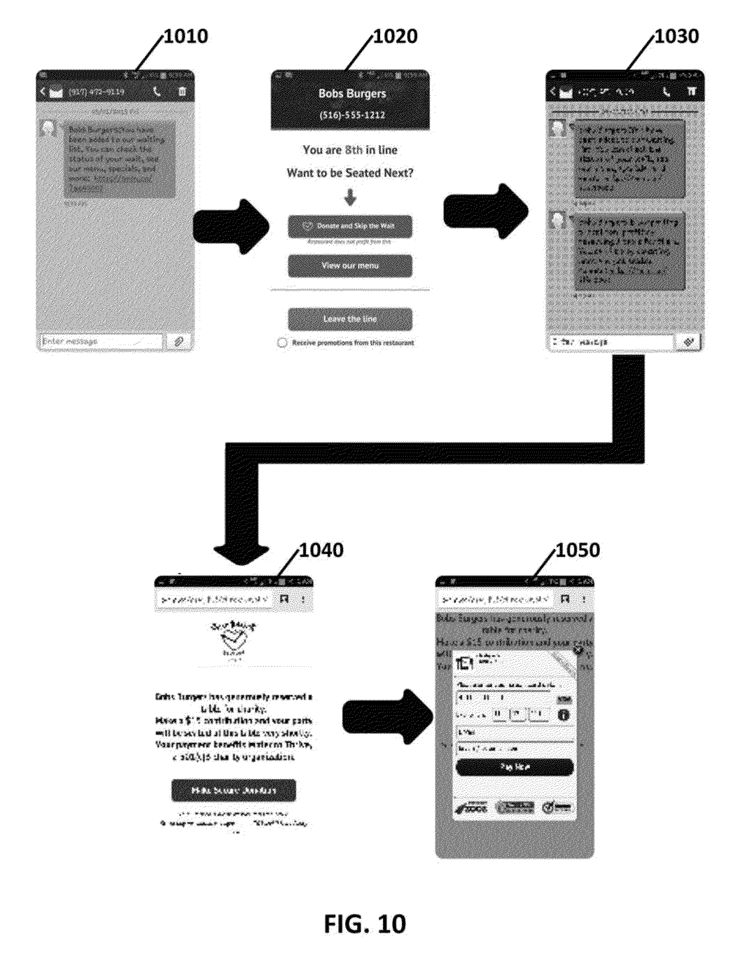

FIG. 10 illustrates screens that are displayed after the screens of FIG. 9 are displayed. Screen 1010 shows that a customer receives a text message with a URL to a charity web page. When the customer clicks the link, a web browser of the customer's mobile device displays the current position of the customer in the waiting list and shows a button for donating to a charity in order to move from the current position to the first position of the waiting list, as shown in screen 1020.

If the customer would like to skip to the first position of the waiting list, the customer may receive another text message including a link to a donation web page, as shown in screen 1030. When the customer clicks the link, screen 1040 is displayed by the web browser of the mobile device to show how to donate to move to the first position of the waiting list. Screen 1040 also shows a button to make a secure donation to a charity. Then, a secure donation payment screen is shown as screen 1050.

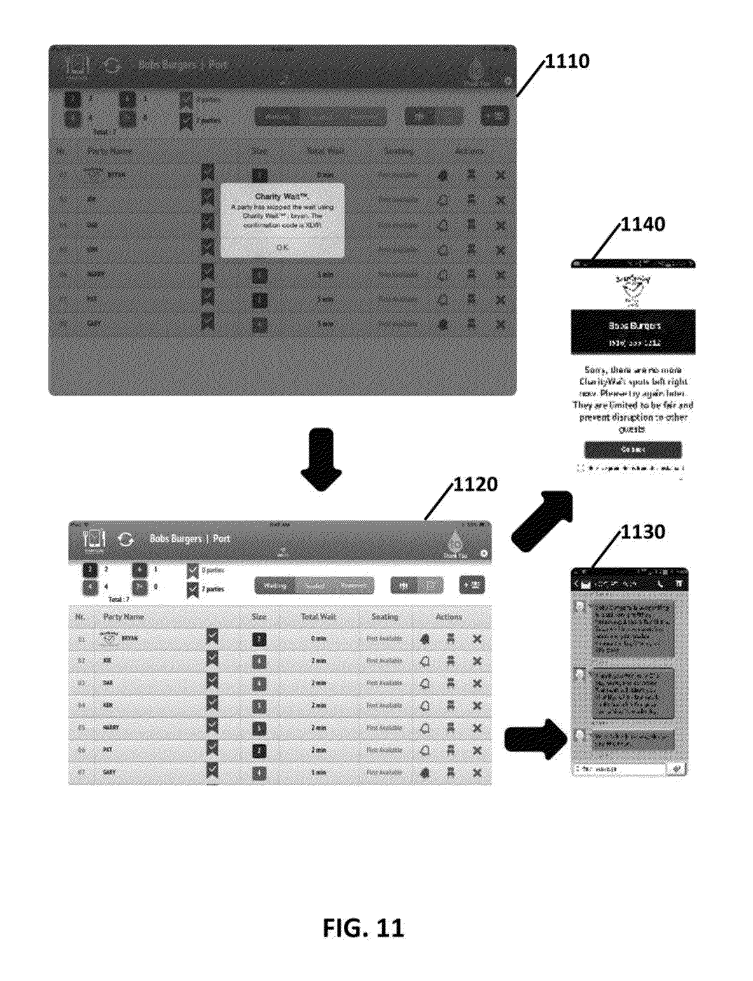

FIG. 11 illustrates screens that are displayed for updating the waiting list after payment of the donation. Screen 1110 shows that the business establishment receives a message indicating that a customer has made a donation to move the customer from the customer's current position to the first position in the waiting list. Screen 1120 shows an updated waiting list. The customer receives another text message indicating that the business establishment is ready to seat the customer in screen 1130. Also, as shown in screen 1140, new customers arriving at the business establishment receive a message indicating that the first position is unavailable until the customer in the first position is seated or until the customer's previous position becomes the first position in the waiting list.

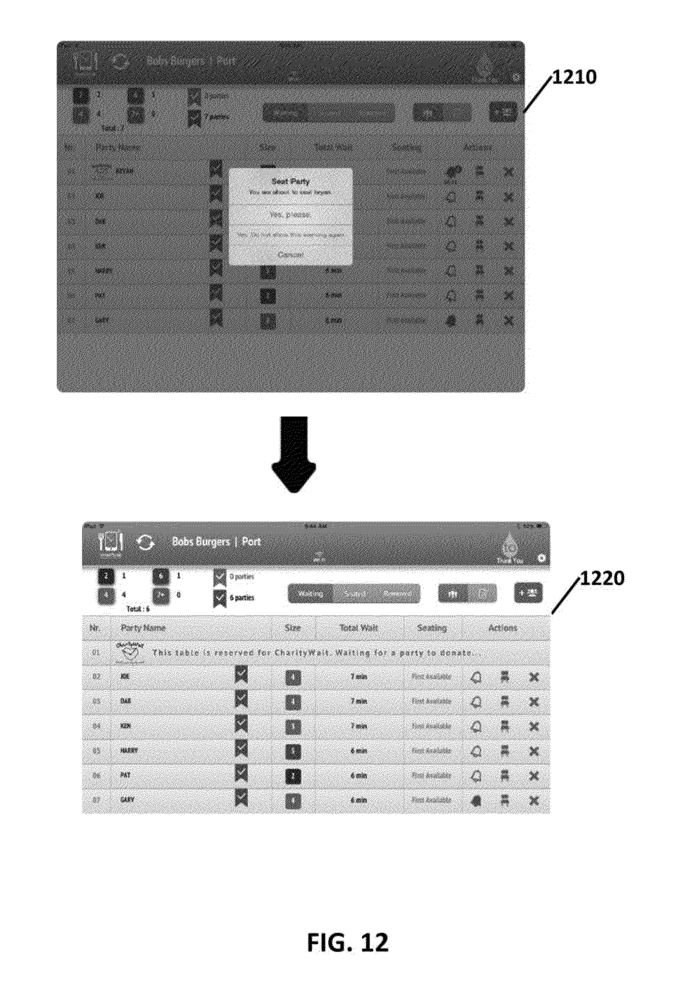

FIG. 12 illustrates screens that are displayed for updating the waiting list after that the screens of FIG. 11 are displayed. When the customer in the first position of the waiting list is about to be seated, the customer receives a seating notification as in screen 1210. If the customer clicks a button to be seated, the customer is seated at the charity seat or at the charity table and the waiting list is updated as shown in screen 1220. The first position is then displayed as being available and the positions of the other customer remain unchanged.

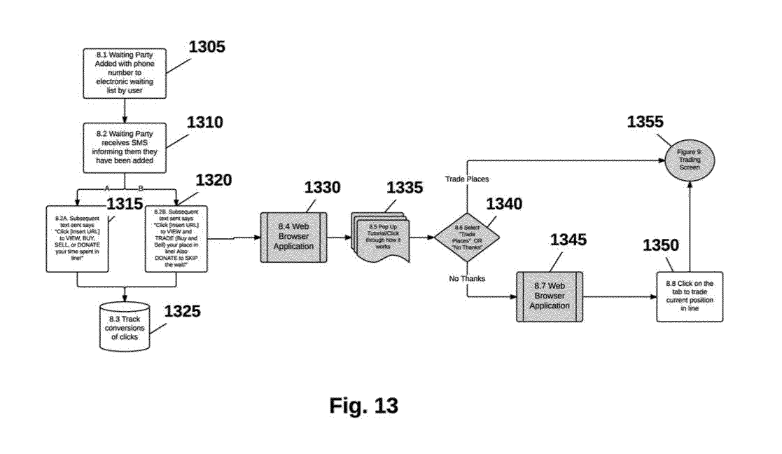

In another embodiment, the waiting customers may exchange their positions with each other independently from the business establishment's control, but still integrating and communicating the results of the position exchange to the business establishment's waiting list program. FIG. 13 illustrates a flowchart for the position exchange. The business establishment uses a waiting list management program to send text messages to customers and the waiting list management program generates a text or in-app message to the customer.

In step 1305, a party or customer may be added to the waiting list by providing the information of the mobile device and the customer. The information of the mobile device may include a phone number and the information of the customer may include the name. In an aspect, the information of the customer may be received through social media, which includes but is not limited to Facebook, LinkedIn, Twitter, Pinterest, Google+, Instagram, or MySpace.

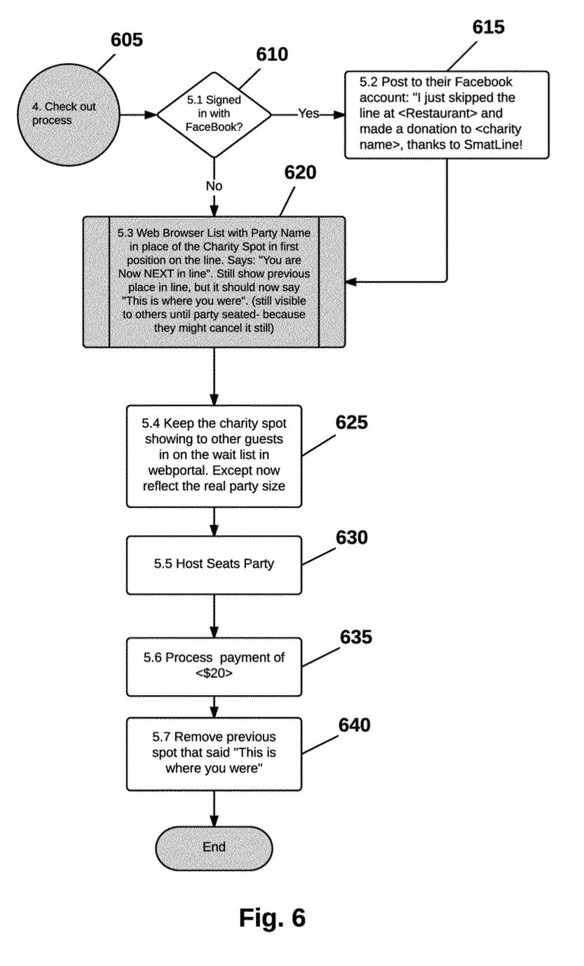

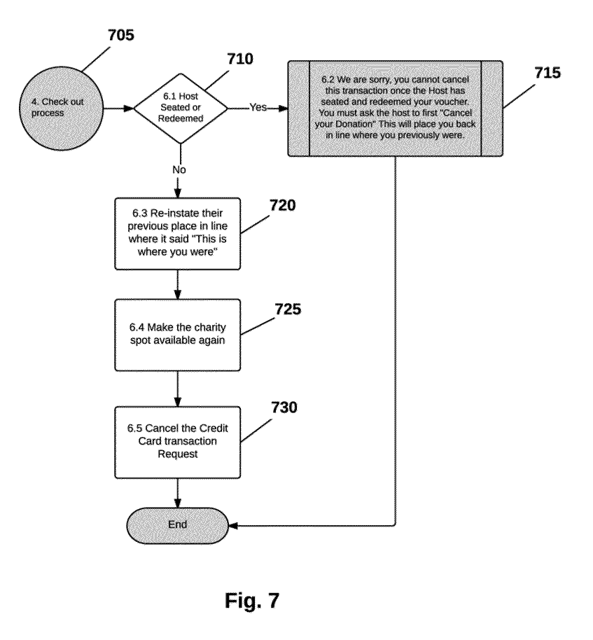

The customer then receives a text message indicating that they have been added to the waiting list. Further, the text message may include a button or link enabling the customer to donate to a charity to skip to the first position of the waiting list in step 1315 or to enable the customer to exchange positions with another customer in step 1320. In the case of the text message in step 1315, the processes detailed in FIGS. 1-12 are performed. The Host server's program may track the number of customers that either donate to a charity or trade positions with other customers.

In step 1330, a web browser of the customer's mobile device is activated and in step 1335, the customer may receive a unique code and a text message containing a link that the customer can click. After clicking this link, the customer may be shown a tutorial explaining that the customer has an option to enter into a transaction and exchange of positions with other customers in the same waiting list in step 1335. The tutorial may also show how to trade positions with another customer in the waiting list, and how customers can be compensated for their time spent waiting by selling their position in line in exchange for a form of compensation from another customer in the waiting list.

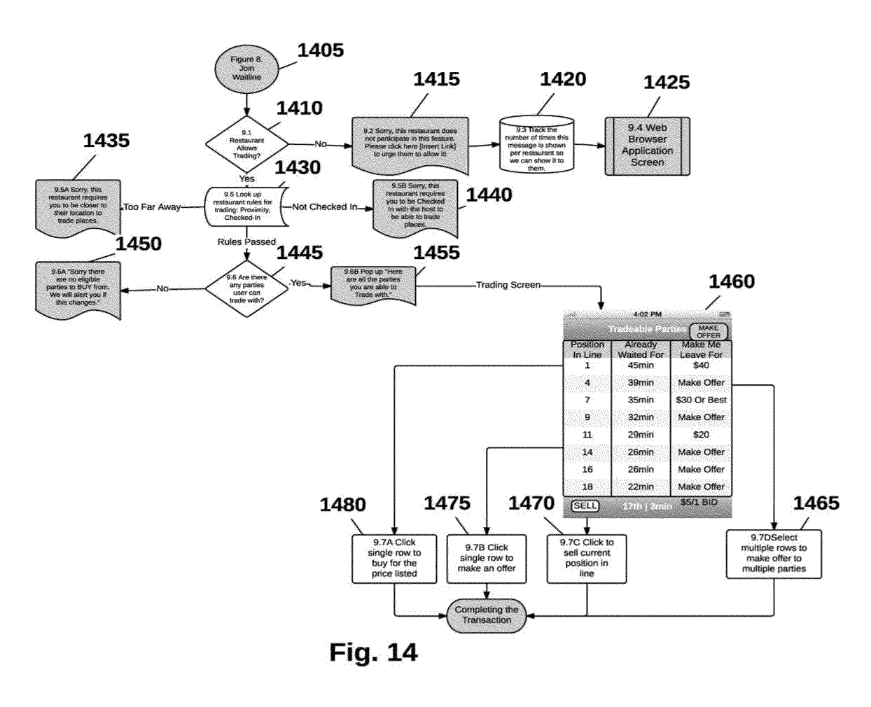

In step 1340, it is determined whether or not the customer has selected a button to initiate the trading of positions in the waiting list. In a case where the customer selects a button to trade positions in the waiting list because the customer agrees to engage in a trade, the customer may be taken to the trading screen to conduct the trade as shown in FIG. 14. In a case where the customer selects a button indicating that the customer does not wish to trade positions in the waiting line, the web browser may be activated in step 1345 and the customer may check whether the customer receives a trade request from another customer in step 1350. If the customer would like to trade the customer's current position with a position of another customer, the process shown in FIG. 14 is executed.

FIG. 14 illustrates a process for trading positions. The trading starts in step 1405 after step 1355 of FIG. 13. In step 1410, it is determined whether or not the business establishment allows trading of positions in the waiting list. If it is determined that trading of positions is not allowed by the business establishment, the customer receives a message indicating that such trading is not allowed at the business establishment in step 1415. The Host server's program may track the number of times customers receive messages indicating that trading is not allowed and may show the statistical results to the owner of the business establishment to persuade the owner to allow such trading of positions. After this, the web browser is also activated to display information related to the business establishment and the statistical results.

When it is determined that the business establishment allows for trading of positions in the waiting list, the rules, which the business establishment has established, are checked in step 1430. The rules may include proximity of the customer from the business establishment or a checked-in status. Based on the rules, the customer may receive a message indicating that the customer is required to be close to the business establishment to start the trading of positions in step 1435 or that the customer is required to check in to initiate the trading in step 1440.

It is also determined whether or not there is any eligible party in the waiting list in step 1445 after passing all the rules. The eligible parties may be any party who is willing to buy or sell the party's current position with others. When it is determined that there is no eligible party, the customer may receive a message informing the customer that no trading is currently possible but that the customer will receive another message after one eligible party appears in the waiting list in step 1450.

When it is determined that there is at least one eligible party, the web browser may pop up a trading screen 1460 showing all eligible parties in step 1455. The trading screen 1460 may provide options to the customer to either buy or sell the customer's current position from or to another party in the waiting list.

There are two optional conditions that the business establishment can enforce before allowing any customer to complete a transaction or exchange a position with another customer in the waiting list. The first condition may require both buyer and seller to be physically present within a specified proximity around the business establishment's location. The second condition may require the buyer and seller to have the same or similar number of people in their respective parties.

In an aspect, the customers may be grouped into parties. For example, the business establishment may decide to only allow customers grouped in party sizes of four or less to be able to purchase or sell or exchange positions with each other in the waiting list. If the above conditions are met, then the customer may be brought to the trading screen 1460 in the application on the customer's Internet or mobile device where they can trade or exchange their positions with other customers in the waiting list. All customers looking at this screen would see what their current position in the waiting list is and a list of other anonymous customers who are selling their current positions in the waiting list. The trading screen 1460 may list each seller in an order of the sellers' positions in the waiting list, how long the sellers have waited, and how much compensation is required for the sellers to sell their positions in the waiting list.

In an aspect, on the bottom of the trading screen 1460, a customer may be able to see if any other customer is willing to buy the customer's current position, how many buyers are interested, if any, how much each buyer is willing to pay, or what each buyer's current position is in the waiting list. At this point the customer may have one or more of the following options: (1) buy a position from an existing customer who is posting a price for their position or asking for an offer for their position; (2) buy a position from an existing customer who is not posting a price and not asking for an offer for their position; or (3) make a current position available for sale to another customer.

According to option (1), if the customer or user chooses to buy a position of another customer, the customer can simply select a single row in the trading screen 1460 from another customer who is making their position in the waiting list available for sale for a specific amount of compensation in step 1480, or a customer who is asking for a buyer to make them an offer for a specific amount of money in step 1475. The buyer can also select multiple parties to make offers in step 1465. When the buyer determines the position or positions the buyer would like to buy, the buyer can agree to pay the price that the seller has specifically listed in step 1480, or the buyer can ask the seller to accept a different amount in step 1475. Either way, the seller may then be asked to verify the purchase price offered by the buyer, and confirm again that they will agree to sell and exchange their current position with this particular buyer. If the Seller confirms, the transaction exchange is agreed by both parties, the exchange is concluded, and the transaction is completed. The buyer is bound to their purchase price for a predetermined period, which may be three minutes or longer. If the seller responds after the predetermined period, then the buyer has an option to agree or rescind the offer to purchase.

According to option (2), the customer makes an offer to buy the position of another customer, who is not actively making their current position in the waiting list available for sale. The buyer can distribute an offer to these customers through the Host server's customer application. These potential sellers may be made aware that there is a buyer interested in purchasing their position in the waiting list. From either a text message sent by the Host server's customer application or within the Host server's customer application itself, the potential seller may see that there is a bid for their position, the bid amount, and the position for which they would be exchanging their current position as shown at the bottom of the trading screen 1460.

The Host server customer application may identify whether the potential seller is using the Host server's customer application. If the potential seller is not using the Host server's customer application, then the Host server may send a text message to the potential seller notifying them that there is a customer willing to purchase their position. If they would like to review and accept the offer, the potential seller may need to click a link in the text, which leads them through the same process as described above for option (1). The Host server may use the buyer and seller's phone number to identify their positions in line and show the offers being made to each other.

According to option (3), if a customer chooses to make their position in line available for sale, then the customer simply clicks a “Sell” button as shown at the bottom of the trading screen 1460. The customer may be brought to a screen within the Host server's customer application that captures how much the customer is willing to sell the current position for, if the buyer wishes to specify a price or if the buyer is willing to let the potential buyer make an offer. The seller may be reminded that once the seller submits this offer, the seller may be able to confirm or reject any potential offers from a buyer.

In an aspect, the seller may review all purchase offers, but may have to act on them quickly as the offers are only valid for the predetermined period, such as three minutes. After the predetermined period, the price is considered stale, and the buyer has the right to rescind or change their purchase price and re-submit it to the seller for approval. The buyer may be always bound to their purchase price for the predetermined period, while the seller may be always the last to agree to the final price during the transaction.

Once an exchange of positions in the waiting list is agreed upon between the buyer and the seller, the buyer may have an option to log into the Host server's customer application and complete the transaction with the buyer's stored payment details. If the buyer does not have a login ID or cannot log into the buyer's account, the buyer may also have an option to go directly to a checkout screen and provide payment details. Either way, after the payment details are captured by the Host server's customer application, the compensation amount is transferred from the buyer's personal bank account to an account set up by the Host-less transaction and commission fees collected by the Host server.

In an aspect, the compensation may not be transferred to the seller's personal bank account. Instead the seller may be given a credit in an amount equal to what the buyer pays for the seller's position in the waiting list, less the transaction and commission fee paid to the Host server. The actual money may transfer from the buyer's personal bank account to the account set up by the Host server. The Host server may then transfer the money, less transaction and commission fees, to the business establishment in whose waiting list the exchange of wait list positions took place.

In an aspect, the business establishment, in exchange for this money, agrees to offer products and services to the seller equal to or greater in value than the credit amount in the seller's account. The seller may be able to redeem this credit amount with the business establishment at any future date and time directly with the business establishment using the Host server's customer application.

The business establishment may be aware of this transaction and their waiting list will automatically reflect the change in party details as shown in FIGS. 9-12. The business establishment may be provided with access through the Host server's application to view a list of all customers who earned a credit to the business establishment as a result of selling and exchanging their positions in the waiting list. The business establishment may be able to decrement the credit amounts from the seller's account balance when the seller chooses to redeem their credits for products and services offered by the business establishment.

Aspects of the present disclosure can also be realized by a computer of a system or apparatus (or devices such as a CPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

Although the illustrative embodiments of the present disclosure have been described herein with reference to the accompanying drawings, it is to be understood that the disclosure is not limited to those precise embodiments, and that various other changes and modification may be effected therein by one skilled in the art without departing from the scope or spirit of the disclosure.

What is claimed is:

1. A method of moving positions in a waiting list in exchange for a donation to charity using a mobile device, the method comprising:
receiving information regarding a mobile device and a user of the mobile device at a database server to set a current position in a waiting list at a business establishment;
sending a message to the mobile device, wherein the message includes a link and notifies the user of a user's position in a waiting list of the business establishment;
determining whether the link displayed on the mobile device is selected;
providing a web page to the mobile device enabling the user to make an electronic payment to a charity, if the link is selected;
determining whether confirmation of a payment for the donation to charity by the user of the mobile device has been received from a payment server;
updating the user's current position to a new position in the waiting list if it is determined that confirmation of a payment for the donation to charity by the user of the mobile device has been received from a payment server; and
notifying the business establishment and the user of the updated user's position as the new position.

2. The method according to claim 1, wherein the information regarding the mobile device is a mobile number assigned to the mobile device, and
wherein the information regarding the user includes a name of the user.

3. The method according to claim 1, wherein the new position is a position in a waiting list reserved for a user who makes an electronic payment to a charity.

4. The method according to claim 1, wherein the business establishment reserves one or more seats for a user who makes an electronic payment to a charity.

5. The method according to claim 4, wherein the number of persons in the new position is less than or equal to a number of the one or more reserved seats.

6. The method according to claim 4, wherein providing the new position in the waiting list includes:
determining whether a reserved seat is available;
providing the reserved seat to the user if the reserved seat is determined to be available; and
setting the new position as being available if the reserved seat is determined to be available.

7. The method according to claim 1, wherein the business establishment selects the charity and an amount of a donation and displays the charity and the amount of the donation to the user.

8. The method according to claim 1, wherein the message is a text message or a chat message.

9. The method according to claim 1, wherein the new position is a first position at the front of the waiting list.

10. The method according to claim 1, wherein the business establishment is a restaurant, a retailer, or any business entity where a user pays for a service that the business establishment offers.

11. The method according to claim 1, further comprising maintaining the user's current position in the waiting list if it is determined that the link is not selected.

12. The method according to claim 1, wherein the information regarding the mobile device and the user of the mobile device is received from a social media server.

13. The method according to claim 12, wherein the social media server is for social media, which includes Facebook, LinkedIn, Twitter, Pinterest, Google+, Instagram, or MySpace.

14. The method according to claim 1, wherein providing the web page includes:
determining whether the new position is available; and
sending a second message to the user that the new position is not available if it is determined that the new position is not available.

15. The method according to claim 14, wherein the second message informs the user that the user maintains the user's current position in the waiting list.

16. A non-transitory computer-readable medium storing instructions that, when executed by a computer, implement a method of moving positions in a waiting list in exchange for a donation to charity using a mobile device, the method comprising:
receiving information regarding a mobile device and a user of the mobile device at a database server to reserve a position in a waiting list at a business establishment;
sending a message to the mobile device, wherein the message includes a link and notifies the user of the user's current position in a waiting list of the business establishment;
determining whether the link displayed on the mobile device is selected;
providing a web page to the mobile device enabling the user to make an electronic payment to a charity, if the link is selected;
determining whether confirmation of a payment for the donation to charity by the user of the mobile device has been received from a payment server;
updating the user's current position to a new position in the waiting list if it is determined that confirmation of a payment for the donation to charity by the user of the mobile device has been received from a payment server; and
notifying the business establishment and the user of the updated user's current position as the new position.

17. A server for changing positions in a waiting list in exchange for a donation to charity, the server comprising:
a memory configured to store a waiting list of a business establishment;
a network device configured to receive information from a mobile device and transmit a message to the mobile device, wherein the message includes a link and notifies a user of the mobile device of a user's current position in the waiting list at the business establishment; and
a processor configured to:
determine whether the link displayed on the mobile device is selected;
provide a web page to the mobile device enabling the user to make an electronic payment to the charity, if it is determined that the link is selected;
determine whether confirmation of a payment for the donation to the charity by the user has been received from a payment server;
update the user's current position to a new position in the waiting list stored in the memory if it is determined that the confirmation has been received; and
notify the business establishment and the user of the updated user's current position as the new position.

18. The server according to claim 17, wherein the information regarding the mobile device is a mobile number assigned to the mobile device.

19. The server according to claim 17, wherein the message is a text message or a chat message.

20. The server according to claim 17, wherein the new position is a first position at the front of the waiting list.
